(19) United States
(12) Patent Application Publication
(10) Pub. No.: US 2018/0029029 A1
(43) Pub. Date: Feb. 1, 2018

(54) OXIDATION CATALYST FOR A COMPRESSION IGNITION ENGINE AND A METHOD OF PREPARATION THEREFOR

(71) Applicant: Johnson Matthey Public Limited Company, London (GB)

(72) Inventors: Andrew CHIFFEY, Royston (GB); Francois MOREAU, Royston (GB); Paul Richard PHILLIPS, Royston (GB); Freyja WOODS, Royston (GB)

(21) Appl. No.: 15/649,745

(22) Filed: Jul. 14, 2017

(30) Foreign Application Priority Data
Jul. 29, 2016 (GB) 1613125.2

(51) Int. Cl. B01J 35/00; B01J 35/04; B01J 23/58; F01N 3/20; B01D 53/94; B01J 23/42

(52) U.S. Cl. CPC B01J 35/0006; B01D 53/944; B01J 23/42; B01J 23/58; F01N 3/20; B01J 35/04

(57) ABSTRACT

An oxidation catalyst for treating an exhaust gas produced by a compression ignition engine is described. The oxidation catalyst comprises a substrate and a catalytic coating disposed on the substrate, wherein the catalytic coating comprises a mixture of: (a) particles of a first catalytic material for oxidising carbon monoxide (CO) and/or hydrocarbons (HCs); (b) particles of a second catalytic material for oxidising nitric oxide (NO) and/or for absorbing oxides of nitrogen (NOₓ).

### CROSS REFERENCE TO RELATED APPLICATIONS

This application claims priority benefit to Great Britain Patent Application No. 1613125.2 filed on Jul. 29, 2016, which is incorporated herein by reference.

### FIELD OF THE INVENTION

The invention relates to an oxidation catalyst for a compression ignition engine and to a method of preparing the oxidation catalyst. The invention further relates to an exhaust system and to an apparatus or a vehicle comprising the exhaust system. The invention also concerns methods and uses of the oxidation catalyst.

BACKGROUND TO THE INVENTION

Compression ignition engines produce an exhaust emission that generally contains at least four classes of pollutant that are legislated against by inter-governmental organisations throughout the world: carbon monoxide (CO), unburned hydrocarbons (HCs), oxides of nitrogen (NOₓ) and particulate matter (PM). Emissions control devices known as oxidation catalysts (or diesel oxidation catalysts) are commonly used to treat carbon monoxide (CO) and hydrocarbons (HCs), including the volatile organic fraction (VOF) of particulate matter (PM), in exhaust emissions produced by compression ignition engines. Such catalysts treat carbon monoxide (CO) by oxidising it to carbon dioxide (CO₂), and treat hydrocarbons (HCs) by oxidising them to water (H₂O) and carbon dioxide (CO₂).

Oxidation catalysts for compression ignition engines typically comprise one or more platinum group metals (PGMs) and a support material, which are coated onto a surface of a substrate. The active component of the oxidation catalyst typically comprises particles of the PGM(s) in metallic or oxide form, which are dispersed over the surfaces of particles of the support material. The active component is typically formed in situ during the manufacture of the oxidation catalyst from one or more salts of the PGM(s) and the support material. The support material and the PGM salts are typically dispersed in a washcoat, which is coated onto and adheres to a surface of the substrate. The coated substrate is usually then dried and calcined, which converts the PGM salts into a metallic PGM or an oxide thereof and fixes it onto a surface of the support material.

Due to increasingly stringent emissions legislation, there is a demand for oxidation catalysts having superior activity and which can perform several functions. This has resulted in the development of oxidation catalysts containing several active components. When the active components are prepared by coating a single washcoat layer onto a substrate, then problems can arise with controlling the location of the PGMs and/or other components of the catalyst composition, such as base metals, on the support materials (i.e. the desired PGM and/or base metal may not be fixed onto the surface of the desired support material). The resulting catalyst composition may contain a series of by-products. These by-products can have poor activity or do not provide the desired functionality.

Recently, oxidation catalysts having several, distinct catalytic regions have been prepared. Each catalytic region is typically formulated to perform one or more specific functions in treating the exhaust gas produced by an engine. These catalytic regions have been arranged on the substrate in layers or have been distributed along the length of the substrate in zones. Oxidation catalysts having zoned and/or layered catalytic regions have been prepared for a variety of reasons. Zoning or layering permits the segregation of active components that are associated with a specific functionality. It is also thought that zoning or layering can modify the activity of the overall oxidation catalyst by controlling the order in which the exhaust gas comes into contact with the active components as the gas passes through the zones or layers.

To manufacture layered or zoned catalysts, it is necessary to perform a coating operation for each layer or zone that is formed on the substrate. This typically involves drying a washcoat onto the substrate to permanently form a layer or a zone before a further layer or zone can be applied. In some instances, it may also be necessary to calcine the washcoat before any subsequent washcoat can be applied to form a further layer or zone. Generally, manufacturing processes for layered or zoned oxidation catalysts require additional coating and drying steps, which increases their production cost and the complexity of the manufacturing process.

There is a need to provide oxidation catalysts for compression ignition engines that meet existing and future environmental legislation, which can also be manufactured in a cost-effective manner whilst providing good activity and functionality.

### SUMMARY OF THE INVENTION

The inventors have devised an oxidation catalyst that has good oxidising activity toward pollutants in an exhaust gas produced by a compression ignition engine, particularly in the oxidation of carbon monoxide (CO), hydrocarbons (HCs) and nitric oxide (NO). The oxidation catalyst of the invention may show comparable oxidative activity toward CO, HCs and/or NO as a zoned or layered catalyst having the same overall content of catalytic materials. The oxidation catalyst of the invention is also convenient to manufacture because it generally requires fewer coating steps and/or drying steps involving the substrate.

The invention provides an oxidation catalyst for treating an exhaust gas produced by a compression ignition engine. The oxidation catalyst comprises a substrate and a catalytic coating disposed on the substrate, wherein the catalytic coating comprises a mixture of:
(a) particles of a first catalytic material for oxidising carbon monoxide (CO) and/or hydrocarbons (HCs);
(b) particles of a second catalytic material for oxidising nitric oxide (NO) and/or for absorbing oxides of nitrogen (NOₓ).

A further aspect of the invention is an exhaust system for treating an exhaust gas produced by a compression ignition engine. The exhaust system comprises the oxidation catalyst of the invention.

The invention also provides an apparatus or a vehicle. The apparatus or vehicle comprises a compression ignition engine and either an exhaust system of the invention or an oxidation catalyst of the invention.

Another aspect of the invention relates to a method of preparing an oxidation catalyst for a compression ignition engine. The method comprises:
(i) preparing a washcoat comprising:
   (a) particles of a first catalytic material for oxidising carbon monoxide (CO) and/or hydrocarbons (HCs), and
   (b) particles of a second catalytic material for oxidising nitric oxide (NO) and/or for absorbing oxides of nitrogen (NOₓ),
   by dispersing the particles of the first catalytic material and the particles of the second catalytic material in a liquid; and
(ii) coating a substrate with the washcoat.

The oxidation catalyst may be obtainable or obtained from the method of preparing the oxidation catalyst of the invention.

Another aspect of the invention relates to a method of treating an exhaust gas produced by a compression ignition engine, wherein the method comprises passing the exhaust gas through an oxidation catalyst of the invention or an exhaust system of the invention. This aspect of the invention further relates to the use of an oxidation catalyst of the invention or an exhaust system of the invention to treat an exhaust gas produced by a compression ignition engine.

### DETAILED DESCRIPTION OF THE INVENTION

The invention is based on the recognition that certain combinations of catalytic materials can be pre-prepared (e.g. isolated in a solid, powder form), and then applied onto a substrate in a single coating step to form a single catalytic coating (i.e. washcoat region). The washcoat region that is formed by this method comprises a mixture of the catalytic materials. Since each of the catalytic materials is pre-prepared, usually in solid form, it is unnecessary to perform multiple coating steps, drying steps and/or calcining steps to form each catalytic material in situ on the substrate. During the preparation of each catalytic material, the platinum group metal(s) and/or other active component(s) can be fixed onto a support material. Fixing the platinum group metal(s) and/or other active components onto the support material may avoid the need to segregate two or more components of the catalyst into separate layers or zones because they may be chemically incompatible without affecting their catalytic activity.

The oxidation catalyst of the invention comprises a catalytic coating that comprises, or consists essentially of, a mixture of (a) particles of the first catalytic material and (b) particles of the second catalytic material. The mixture is preferably a homogeneous mixture (e.g. a homogeneous mixture of (a) and (b)).

For the avoidance of doubt, the first catalytic material and the second catalytic material are different (i.e. the first catalytic material has a different composition to the composition of the second catalytic material). Thus, the particles of the first catalytic material are different to the particles of the second catalytic material.

The catalytic coating may further comprise, or consist essentially of, a mixture of (a) particles of the first catalytic material, (b) particles of the second catalytic material, and (c) particles of a third catalytic material. Typically, the mixture is a homogeneous mixture (e.g. a homogeneous mixture of (a), (b) and (c)).

Typically, the catalytic coating comprises, or consists essentially of, a mixture of (a) particles of the first catalytic material for oxidising carbon monoxide (CO) and/or hydrocarbons (HCs); (b) particles of the second catalytic material for oxidising nitric oxide (NO) and/or for absorbing oxides of nitrogen (NOₓ); and (c) particles of a third catalytic material, preferably wherein the third catalytic material is selected from a catalytic material for trapping volatilised platinum (Pt), a catalytic material for absorbing hydrocarbons (HCs) and a catalytic material for absorbing oxides of nitrogen (NOₓ). When the particles of the second catalytic material are for absorbing oxides of nitrogen (NOₓ), it may be preferable that the particles of a third catalytic material are for trapping volatilised platinum (Pt) or for absorbing hydrocarbons (HCs).

For the avoidance of doubt, the third catalytic material and the first catalytic material are different (i.e. the third catalytic material has a different composition to the composition of the first catalytic material) and the third catalytic material and the second catalytic material are different (i.e. the third catalytic material has a different composition to the composition of the first catalytic material). Thus, the particles of the third catalytic material are different to the particles of both the first catalytic material and the second catalytic material.

Typically, the catalytic coating is disposed or supported on a substrate, such as a surface of the substrate, particularly a surface of the channel walls of the substrate. The catalytic coating may be disposed directly onto the substrate (i.e. the catalytic coating is in direct contact with the substrate).

The catalytic coating may be a layer or a zone. It is preferred that the catalytic coating is a single layer or a single zone, more preferably a single layer.

The oxidation catalyst may preferably comprise, or consist essentially of, a substrate and a catalytic coating disposed on the substrate, wherein the catalytic coating is a single layer (e.g. the catalytic coating is the only catalytic coating disposed on the substrate).

Typically, the ratio by weight/molar ratio of the first catalytic material to the second catalytic material is >1:4, preferably >1:2, more preferably >1:1 (e.g. >1.5:1).

When the catalytic coating comprises a third catalytic material, then typically the ratio by weight/molar ratio of the second catalytic material to the third catalytic material is >1:4, preferably >1:2, more preferably >1:1 (e.g. >1.5:1).

In general, the substrate is a monolith (also referred to herein as a substrate monolith). Such monoliths are well-known in the art. The substrate monolith may be a flow-through monolith. Alternatively, the substrate monolith may be a filtering monolith.

A flow-through monolith typically comprises a honeycomb monolith (e.g. a metal or ceramic honeycomb monolith) having a plurality of channels extending therethrough, wherein each channel is open at both ends (i.e. an open end at the inlet and an open end at the outlet). The channels are formed between a plurality of walls. The walls generally comprise a non-porous material.

A filtering monolith generally comprises a plurality of inlet channels and a plurality of outlet channels, wherein the inlet channels are open at an upstream end (i.e. exhaust gas inlet side) and are plugged or sealed at a downstream end (i.e. exhaust gas outlet side), the outlet channels are plugged or sealed at an upstream end and are open at a downstream end. Each channel is typically separated from an adjacent or neighbouring channel by a wall. The wall comprises, or consists essentially of, a porous material. Such porous materials are well known in the art.

When the monolith is a filtering monolith, it is preferred that the filtering monolith is a wall-flow filter. In a wall-flow filter, each inlet channel is alternately separated from an outlet channel by a wall of the porous structure and vice versa. It is preferred that the inlet channels and the outlet channels are arranged in a honeycomb arrangement. When there is a honeycomb arrangement, it is preferred that the channels vertically and laterally adjacent to an inlet channel are plugged at an upstream end and vice versa (i.e. the channels vertically and laterally adjacent to an outlet channel are plugged at a downstream end). When viewed from either end, the alternately plugged and open ends of the channels take on the appearance of a chessboard.

The invention may be particularly beneficial when the substrate is a filtering monolith. Coated filtering monoliths are susceptible to build-ups of back pressure within an exhaust system. The coating may restrict the passage of exhaust gas through the walls of the filtering monolith. The oxidation catalyst of the invention can provide many of the activity benefits associated with zoned or layered coatings on a filtering monolith, but may avoid problems associated with high back-pressure because the catalytic materials are disposed in single layer.

In principle, the substrate may be of any shape or size. However, the shape and size of the substrate is usually selected to optimise exposure of the catalytic materials to the exhaust gas. The substrate may, for example, have a tubular, fibrous or particulate form. Examples of suitable supporting substrates include a substrate of the monolithic honeycomb cordierite type, a substrate of the monolithic honeycomb SiC type, a substrate of the layered fibre or knitted fabric type, a substrate of the foam type, a substrate of the crossflow type, a substrate of the metal wire mesh type, a substrate of the metal porous body type and a substrate of the ceramic particle type.

The present invention will now be further described. The following sections relate to different parts of the oxidation catalyst of the invention and define each part in more detail. Each part of the oxidation catalyst (e.g. the first, second or third catalytic material etc.) may be combined with any other part of the oxidation catalyst unless clearly indicated to the contrary. In particular, any feature indicated as being preferred or advantageous may be combined with any other feature or features indicated as being preferred or advantageous.

The first catalytic material is (e.g. is formulated) for oxidising carbon monoxide (CO) and/or hydrocarbons (HCs) in an exhaust gas produced by a compression ignition engine, preferably carbon monoxide (CO) and hydrocarbons (HCs) in an exhaust gas produced by a compression ignition engine. It is intended that this function is the primary function of the first catalytic material. However, it is appreciated that in some embodiments of the invention, the first catalytic material may provide other functionality, albeit to a lesser extent than its primary functionality.

A first aspect of the first catalyst material comprises, or consists essentially of, (i) platinum (Pt), (ii) a support material, and (iii) a component selected from the group consisting of palladium (Pd), a promoter and a combination of palladium and a promoter.

In all aspects of the first catalytic material described herein, the support material of the first catalytic material is referred to herein as the “first support material”. The label “first” is used herein to distinguish the support material of the first catalytic material from the support materials of any other catalytic materials.

Generally, the platinum is supported on the first support material. The platinum may be disposed directly onto or is directly supported by the first support material (e.g. there is no intervening support material between the platinum and the first support material). The platinum is supported on the first support material by being dispersed over a surface of the first support material, more preferably by being dispersed over, fixed onto a surface of and/or impregnated within the first support material.

Particles of platinum are typically supported on particles of the first support material. It is preferred that a particle of platinum is supported on a particle of the first support material (i.e. a surface of a particle of the first support material).

The first catalytic material may comprise, or consist essentially of, platinum (Pt), palladium (Pd) and a support material. The first catalytic material may comprise, or consist essentially of, a platinum-palladium alloy and a first support material. The platinum-palladium alloy is preferably a bimetallic platinum-palladium alloy. However, it may be preferable that the first catalytic material does not comprise a platinum-palladium alloy.

The palladium is typically supported on the first support material. In general, the palladium may be disposed directly onto or is directly supported by the first support material (e.g. there is no intervening support material between the palladium and the first support material. The palladium is supported on the first support material by being dispersed over a surface of the first support material, more preferably by being dispersed over, fixed onto a surface of and/or impregnated within the first support material.

When the first catalytic material comprises platinum and palladium, and preferably when the first catalytic material does not comprise a promoter, the ratio by mass of platinum to palladium in the first catalytic material is typically 25:1 to 1:10, preferably 10:1 to 1:4, such as 5:1 to 1:3 (e.g. 4:1 to 1:2).

It may be preferable that the ratio by mass of platinum to palladium in the first catalytic material is ≧1:1. The ratio by mass of platinum to palladium in the first catalytic material may be 25:1 to 1.1:1, such as 10:1 to 1.5:1, preferably 5:1 to 2:1.

In general, when the first catalytic material comprises platinum and palladium, and particularly when the first catalytic material does not comprise a promoter, it is preferred that the ratio by mass of platinum to palladium in the first catalytic material is less than the ratio by mass of platinum to palladium in the second catalytic material.

The first catalytic material may comprise, or consist essentially of, platinum (Pt), a promoter and a support material. The first catalytic material may comprise, or consist essentially of, platinum (Pt), palladium (Pd), a promoter and a support material.

When the first catalytic material includes a promoter, then preferably the promoter is supported on the first support material. More preferably, the promoter is disposed directly onto or is directly supported by the first support material. The promoter (e.g. particles of the promoter) is typically supported on the first support material by being dispersed over a surface of the first support material, more preferably by being dispersed over, fixed onto a surface of and/or impregnated within the first support material.

The promoter may comprise, or consist essentially of, (i) an alkaline earth metal or an oxide, hydroxide or carbonate thereof, and/or (ii) bismuth or an oxide thereof. The inclusion of such a promoter can enhance the oxidative activity of the catalytic material toward carbon monoxide (CO) and/or hydrocarbons (HCs).

The promoter may comprise, or consist essentially of, an alkaline earth metal or an oxide, hydroxide or carbonate thereof. The alkaline earth metal may be selected from magnesium (Mg), calcium (Ca), strontium (Sr), barium (Ba) and a combination of two or more thereof. The alkaline earth metal is preferably calcium (Ca), strontium (Sr), or barium (Ba), more preferably strontium (Sr) or barium (Ba), and most preferably the alkaline earth metal is barium (Ba).

When the promoter is an alkaline earth metal or an oxide, hydroxide or carbonate thereof, then typically the ratio of the total mass of the alkaline earth metal to the total mass of the platinum group metal (e.g. platinum and optionally palladium [i.e. when present]) in the first catalytic material is 0.25:1 to 20:1 (e.g. 0.3:1 to 20:1). It is preferred that the ratio of the total mass of the alkaline earth metal to the total mass of the platinum group metal in the first catalytic material is 0.5:1 to 17:1, more preferably 1:1 to 15:1, particularly 1.5:1 to 10:1, still more preferably 2:1 to 7.5:1, and even more preferably 2.5:1 to 5:1. It is preferred that the total mass of the alkaline earth metal is greater than the total mass of the platinum (Pt) in the first catalytic material.

Generally, when the promoter is an alkaline earth metal, the ratio of the total mass of the alkaline earth metal to the total mass of the first support material is 1:200 to 1:5, preferably 1:150 to 1:10, even more preferably 1:100 to 1:20.

When the first catalytic material comprises both palladium and an alkaline earth metal or an oxide, hydroxide or carbonate thereof as a promoter, then typically the ratio by mass of platinum to palladium in the first catalytic material is ≧1:2, such as ≧35:65 (e.g. ≧7:13). It is preferred that the ratio by mass of platinum to palladium in the first catalytic material is ≧40:60 (e.g. ≧2:3), more preferably ≧42.5:57.5 (e.g. ≧17:23), particularly ≧45:55 (e.g. ≧9:11), such as ≧47.5:52.5 (e.g. ≧19:21), and still more preferably ≧50:50 (e.g. ≧1:1).

Generally, when the first catalytic material comprises palladium and an alkaline earth metal or an oxide, hydroxide or carbonate thereof as a promoter, the ratio by mass of platinum to palladium in the first catalytic material is typically 10:1 to 1:2. It is preferred that the ratio by mass of platinum to palladium in the first catalytic material is 8:1 to 7:13, such as 80:20 to 35:65 (e.g. 4:1 to 7:13), more preferably 75:25 to 40:60 (e.g. 3:1 to 2:3), such as 70:30 to 42.5:57.5 (e.g. 7:3 to 17:23), even more preferably 67.5:32.5 to 45:55 (e.g. 27:13 to 9:11), such as 65:35 to 47.5:52.5 (e.g. 13:7 to 19:21), and still more preferably 60:40 to 50:50 (e.g. 3:2 to 1:1).

The first catalytic material may have advantageous oxidative activity toward carbon monoxide (CO) and/or hydrocarbons (HCs) when it comprises platinum, palladium and an alkaline earth metal as a promoter, and when the mass of palladium is less than the mass of platinum.

The promoter may comprise, or consist essentially of, bismuth or an oxide thereof. The oxide of bismuth is typically bismuth (III) oxide (Bi₂O₃).

The promoter may comprise, or consist essentially of, bismuth or an oxide thereof. As mentioned above, the promoter is supported on the first support material. Additionally or alternatively, the first support material may comprise, or consist essentially of, a refractory oxide comprising bismuth or an oxide thereof, such as bismuth (III) oxide (Bi₂O₃). The bismuth promoter can be part of the support material. For the avoidance of doubt, the support material or the refractory oxide thereof is not bismuth or an oxide thereof (i.e. the support material or the refractory oxide thereof is not solely bismuth or an oxide thereof).

When the promoter comprises bismuth or an oxide thereof, then preferably the first support material is a particulate refractory oxide. The bismuth or an oxide thereof is typically (i) dispersed over a surface of the particulate refractory oxide and/or (ii) contained within the bulk particulate structure of the refractory oxide.

The particulate refractory oxide may be impregnated with bismuth or an oxide thereof. Thus, for example, particles of a refractory oxide (e.g. a mixed or composite oxide of silica-alumina or alumina doped with silica) may be impregnated with bismuth or an oxide thereof. A particulate refractory oxide may be impregnated with bismuth or an oxide thereof using conventional techniques that are known in the art.

The particulate refractory oxide preferably comprises pores (i.e. it is porous). The bismuth or oxide thereof is preferably in the pores (e.g. of the particulate refractory oxide). When the particulate refractory oxide is impregnated with bismuth or an oxide thereof, then bismuth or oxide thereof will be present in the pores of the particulate refractory oxide.

Additionally or alternatively, the refractory oxide is doped with bismuth or an oxide thereof.

It is to be understood that any reference to “doped” as used herein in this context refers to a material where the bulk or host lattice of the refractory oxide is substitution doped or interstitially doped with a dopant. In some instances, small amounts of the dopant may be present at a surface of the refractory oxide. However, most of the dopant will generally be present in the body of the refractory oxide.

The first catalytic material typically comprises a ratio by mass of platinum group metal (e.g. platinum and optionally palladium [i.e. when present]) to bismuth (Bi) of 10:1 to 1:10 (e.g. 1:1 to 1:10), preferably 4:1 to 1:7.5 (e.g. 1:1.5 to 1:7.5), more preferably 2:1 to 1:5, particularly 1:1 to 1:4.

When the promoter comprises bismuth or an oxide thereof, the first catalytic material, particularly the refractory oxide, may further comprise tin (Sn) or an oxide thereof. The oxide of tin is typically tin (II) oxide (SnO) and/or tin dioxide (SnO₂). When tin or an oxide thereof is included, the sintering resistance of platinum can be improved and/or an improvement in HC oxidation activity may be obtained.

A second aspect of the first catalytic material comprises, or consists essentially of, (i) palladium (Pd), (ii) gold (Au) and (iii) a first support material. The first catalytic material may comprise, or consist essentially of, a palladium-gold (Pd-Au) alloy and a first support material. The palladium-gold alloy is preferably a bimetallic palladium-gold alloy. Palladium-gold alloys can be prepared using the method described in WO 2012/120292.

The palladium and gold is each supported on the first support material. In general, the palladium and gold may each be disposed directly onto or is directly supported by the first support material (e.g. there is no intervening support material between (i) the palladium and the first support material and (ii) the gold and the first support material).

The palladium and gold are supported on the first support material preferably by being dispersed over a surface of the first support material, more preferably by being dispersed over and fixed onto a surface of the first support material.

Typically, the first catalytic material comprises a ratio by weight of palladium (Pd) to gold (Au) of 9:1 to 1:9, preferably 5:1 to 1:5, and more preferably 2:1 to 1:2.

A third aspect of the first catalyst material comprises, or consists essentially of, (i) platinum (Pt), (ii) palladium (Pd), (iii) manganese or an oxide thereof, and (iv) a first support material. It has been found that the combination of Pt, Pd and Mn on certain support materials can provide advantageous CO oxidation activity and/or HC oxidation activity.

Generally, the platinum and manganese are supported on the first support material. The platinum and manganese may be disposed directly onto or is directly supported by the first support material (e.g. there is no intervening support material between the platinum, the manganese and the first support material). The platinum and manganese are supported on the first support material by being dispersed over a surface of the first support material, more preferably by being dispersed over, fixed onto a surface of and/or impregnated within the first support material.

Particles of platinum and particles of manganese are typically supported on particles of the first support material. It is preferred that at least one particle of platinum and at least one particle of manganese is supported on a particle of the first support material (i.e. a surface of a particle of the first support material).

The palladium is typically supported on the first support material. In general, the palladium may be disposed directly onto or is directly supported by the first support material (e.g. there is no intervening support material between the palladium and the first support material. The palladium is supported on the first support material by being dispersed over a surface of the first support material, more preferably by being dispersed over, fixed onto a surface of and/or impregnated within the first support material.

Particles of platinum, palladium and manganese are typically supported on particles of the first support material. It is preferred that at least one particle of platinum, at least one particle of palladium and at least one particle of manganese is supported on a particle of the first support material (i.e. a surface of a particle of the first support material).

In the third aspect, the ratio by mass of platinum to palladium in the first catalytic material is typically ≧1:1, such as ≧1.5:1, and more preferably ≧2:1.

For example, the ratio by mass of platinum to palladium in the first catalytic material may be 25:1 to 1:1, preferably 20:1 to 1.5:1, such as 10:1 to 2:1, more preferably 8:1 to 2.5:1 (e.g. 4:1 to 2.5:1).

A fourth aspect of the first catalyst material comprises, or consists essentially of, a molecular sieve catalyst, wherein the molecular sieve catalyst comprises palladium and a large pore molecular sieve. It has been found that molecular sieve catalyst comprising palladium and a large pore molecular sieve, particularly certain large pore molecular sieves, can provide advantageous HC oxidation activity.

The molecular sieve catalyst may further comprise a second metal (i.e. in addition to the palladium). The second metal may be selected from the group consisting of platinum (Pt), rhodium (Rh), gold (Au), silver (Ag), iridium (Ir) and ruthenium (Ru). The second metal is preferably selected from the group consisting of platinum (Pt) and rhodium (Rh). Even more preferably, the second metal is platinum (Pt). When the noble metal comprises, or consists of, palladium (Pd) and a second metal, then the ratio by mass of palladium (Pd) to the second metal is >1:1. More preferably, the ratio by mass of palladium (Pd) to the second metal is >1:1 and the molar ratio of palladium (Pd) to the second metal is >1:1.

It is preferred that the molecular sieve catalyst does not comprise a second metal as defined above. Thus, the molecular sieve catalyst comprises palladium as the only noble metal (the term “noble metal” in this context refers to ruthenium (Ru), rhodium (Rh), palladium (Pd), silver (Ag), osmium (Os), iridium (Ir), platinum (Pt) and gold (Au)).

The molecular sieve catalyst may further comprise a base metal. The base metal may be selected from the group consisting of iron (Fe), copper (Cu), manganese (Mn), chromium (Cr), cobalt (Co), nickel (Ni), and tin (Sn), as well as mixtures of two or more thereof. It is preferred that the base metal is selected from the group consisting of iron, copper and cobalt, more preferably iron and copper. Even more preferably, the base metal is iron.

It is preferred that the molecular sieve catalyst is substantially free of a base metal as defined above. Thus, the molecular sieve catalyst does not comprise a base metal as defined above.

The molecular sieve is typically selected from an aluminosilicate zeolite, an aluminophosphate molecular sieve and a silico-aluminophosphate molecular sieve. For example, the molecular sieve is typically selected from an aluminosilicate zeolite and an aluminophosphate molecular sieve. It is preferred that the molecular sieve is selected from an aluminosilicate zeolite and a silico-aluminophosphate molecular sieve. More preferably, the molecular sieve is an aluminosilicate zeolite.

Palladium (and the second metal, when present) is typically loaded onto or supported on the molecular sieve. For example, the palladium (and the second metal, when present) may be loaded onto or supported on the molecular sieve by ion-exchange. Thus, the molecular sieve catalyst may comprise, or consist essentially of, palladium and a molecular sieve, wherein the palladium is loaded onto or supported on the molecular sieve by ion exchange.

In general, the molecular sieve may be a metal-substituted molecular sieve (e.g. metal-substituted aluminosilicate zeolite or metal-substituted aluminophosphate molecular sieve). The metal of the metal-substituted molecular sieve may be the palladium (e.g. the molecular sieve is a palladium substituted molecular sieve). When the molecular sieve catalyst comprises a base metal, then the molecular sieve may be a palladium and base metal-substituted molecular sieve. For the avoidance of doubt, the term “metal-substituted” is synonymous with “ion-exchanged”.

The molecular sieve catalyst generally has at least 1% by weight (i.e. of the amount of palladium of the molecular sieve catalyst) of the palladium located inside pores of the molecular sieve, preferably at least 5% by weight, more preferably at least 10% by weight, such as at least 25% by weight, even more preferably at least 50% by weight.

The molecular sieve is a large pore molecular sieve, which is a molecular sieve having a maximum ring size of twelve tetrahedral atoms.

Typically, the molecular sieve is composed of aluminium, silicon, and/or phosphorus. The molecular sieve generally has a three-dimensional arrangement of SiO₄, AlO₄, and/or PO₄ that are joined by the sharing of oxygen atoms. The molecular sieve may have an anionic framework. The charge of the anionic framework may be counterbalanced by cations, such as by cations of alkali and/or alkaline earth elements (e.g., Na, K, Mg, Ca, Sr, and Ba), ammonium cations and/or protons.

The large molecular sieve preferably has a Framework Type selected from the group consisting of CON, BEA, FAU, MOR and EMT, more preferably BEA. Each of the aforementioned three-letter codes represents a framework type in accordance with the “IUPAC Commission on Zeolite Nomenclature” and/or the “Structure Commission of the International Zeolite Association”.

It is preferred that the large pore molecular sieve is an aluminosilicate zeolite having the BEA Framework Type, more preferably the large pore molecular sieve is beta zeolite.

Generally, the molecular sieve typically has a silica to alumina molar ratio (SAR) of 10 to 200 (e.g. 10 to 40), such as 10 to 100, more preferably 15 to 80 (e.g. 15 to 30). The SAR generally relates to an aluminosilicate zeolite or a silico-aluminophosphate zeolite.

In the first aspect and the third aspect of the first catalytic material, the particles of platinum typically have a mean particle size ≦100 nm, preferably ≦50 nm, such as ≦25 nm, and more preferably ≦10 nm. Generally, the particles of platinum have a mean particle size ≧1 nm, such as ≧5 nm.

In the first aspect, the second aspect and the third aspect of the first catalytic material, the particles of palladium typically have a mean particle size ≦100 nm, preferably ≦50 nm, such as ≦25 nm, and more preferably ≦10 nm. Generally, the particles of palladium have a mean particle size ≧1 nm, such as ≧5 nm.

When the first catalytic material comprises a promoter, particularly a promoter comprising an alkaline earth metal, then typically the particles of the alkaline earth metal have a mean particle size ≦100 nm, preferably ≦50 nm, such as ≦25 nm. Generally, the particles of the alkaline earth metal have a mean particle size ≧1 nm, such as ≧5 nm, preferably ≧10 nm.

In the second aspect of the first catalytic material, the particles of gold typically have a mean particle size ≦100 nm, preferably ≦50 nm, such as ≦25 nm, and more preferably ≦10 nm. Generally, the particles of gold have a mean particle size of ≧1 nm, such as ≧5 nm.

When the first catalytic material comprises an alloy, such as an alloy of platinum and palladium or an alloy of palladium and gold, then the particles of the alloy typically have a mean particle size ≦100 nm, preferably ≦50 nm, such as ≦25 nm, and more preferably ≦10 nm. Generally, the particles of the alloy have a mean particle size ≧1 nm, such as ≧5 nm.

Generally (including the first, second and third aspects of the first catalytic material), the first support material comprises, or consists essentially of, a refractory oxide. The refractory oxide comprises, or consists essentially of, alumina, silica, titania, zirconia or ceria, or a mixed or composite oxide thereof, such as a mixed or composite oxide of two or more thereof. For example, the mixed or composite oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

The refractory oxide may optionally be doped (e.g. with a dopant). The dopant may comprise, or consist essentially of, an element selected from the group consisting of cerium (Ce), zirconium (Zr), titanium (Ti), silicon (Si), yttrium (Y), lanthanum (La), praseodymium (Pr), samarium (Sm), neodymium (Nd) and an oxide thereof. It is preferred that an element (e.g. of the dopant) is different to an element of the refractory oxide. Thus, silica is preferably not doped with silicon.

When the refractory oxide is doped, the total amount of dopant is 0.25 to 5% by weight, preferably 0.5 to 3% by weight (e.g. about 1% by weight).

It may be preferable that the refractory oxide is not doped (e.g. with a dopant).

In the first, second and third aspects of the first catalytic material, the refractory oxide preferably comprises, or consists essentially of, alumina, silica, a mixed or composite oxide of silica and alumina, or ceria.

In the first aspect and the third aspect of the first catalytic material, it is particularly preferred that the refractory oxide comprises alumina, silica or a mixed or composite oxide of silica and alumina. It is preferred that the refractory oxide comprises alumina. More preferably, the refractory oxide is a mixed or composite oxide of silica-alumina.

In general, when the refractory oxide is a mixed or composite oxide of silica-alumina, then preferably the refractory oxide comprises 0.5 to 45% by weight of silica (i.e. 55 to 99. 5% by weight of alumina), preferably 1 to 40% by weight of silica, more preferably 1.5 to 30% by weight of silica (e.g. 1.5 to 10% by weight of silica), particularly 2.5 to 25% by weight of silica, more particularly 3.5 to 20% by weight of silica (e.g. 5 to 20 by weight of silica), even more preferably 4.5 to 15% by weight of silica.

In the first, second or third aspects of the first catalytic material, when the refractory oxide comprises, or consists essentially of, alumina, then the alumina may optionally be doped (e.g. with a dopant). The dopant may comprise, or consist essentially, of silicon (Si) or an oxide thereof. Alumina doped with a dopant can be prepared using methods known in the art or, for example, by a method described in U.S. Pat. No. 5,045,519.

When the alumina is doped with a dopant comprising silicon or an oxide thereof, then preferably the alumina is doped with silica. The alumina is preferably doped with silica in a total amount of 0.5 to 45% by weight (i.e. % by weight of the alumina), preferably 1 to 40% by weight, more preferably 1.5 to 30% by weight (e.g. 1.5 to 10% by weight), particularly 2.5 to 25% by weight, more particularly 3.5 to 20% by weight (e.g. 5 to 20 by weight), even more preferably 4.5 to 15% by weight.

In the second aspect, it is preferable that the refractory oxide comprises, or consists essentially of, ceria or ceria-zirconia, more preferably ceria.

Generally, when the refractory oxide comprises, or consists essentially of, ceria-zirconia, then typically the ceria-zirconia comprises at least 45% by weight ceria, preferably at least 50% by weight ceria, more preferably at least 55% by weight ceria, such as at least 70% by weight ceria. The ceria-zirconia may further comprise a total of 1 to 15 by weight, preferably 2 to 12.5% by weight (e.g. 5 to 10% by weight) of an oxide or oxides of a second rare earth metal (e.g. the second rare earth metal is not cerium). The second rare earth metal is typically selected from the group consisting of lanthanum (La), praseodymium (Pr) and combinations thereof.

Generally, the ceria-zirconia consists essentially of 20 to 95% by weight of ceria and 5 to 80% by weight of zirconia (e.g. 50 to 95% by weight ceria and 5 to 50% by weight zirconia), preferably 35 to 80% by weight of ceria and 20 to 65% by weight zirconia (e.g. 55 to 80% by weight ceria and 20 to 45% by weight zirconia), even more preferably 45 to 75% by weight of ceria and 25 to 55% by weight zirconia.

When the ceria or ceria-zirconia is doped, then the total amount of dopant is 0.1 to 5 by weight (i.e. % by weight of the ceria or the ceria-zirconia). It is preferred that the total amount of dopant is 0.25 to 2.5% by weight, more preferably 0.5 to 1.5% by weight (e.g. about 1% by weight). Ceria may be doped with one or more dopant selected from the group consisting of zirconium (Zr), titanium (Ti), silicon (Si), yttrium (Y), lanthanum (La), praseodymium (Pr), samarium (Sm), neodymium (Nd) and an oxide thereof. Ceria-zirconia may be doped with one or more dopant selected from the group consisting of titanium (Ti), silicon (Si), yttrium (Y), lanthanum (La), praseodymium (Pr), samarium (Sm), neodymium (Nd) and an oxide thereof.

The particles of the first support material typically have a mean particle size ≦250 μm, preferably ≦200 μm, such as ≦150 μm, and more preferably ≦100 μm. Generally, the particles of the first support material have a mean particle size ≧1 μm, such as ≧10 μm.

In general, it is preferred that the first catalytic material does not comprise rhodium, particularly rhodium disposed or supported on the first support material.

For the avoidance of doubt, in the first aspect and the second aspect, the first catalytic material is substantially free of, or does not comprise, manganese.

The second catalytic material is (e.g. is formulated) for oxidising nitric oxide (NO) to nitrogen dioxide (NO₂) and/or absorbing oxides of nitrogen (NOₓ), preferably for oxidising nitric oxide (NO) to nitrogen dioxide (NO₂) or absorbing oxides of nitrogen (NOₓ). It is intended that the aforementioned function(s) is/are the primary function(s) of the second catalytic material. However, it is appreciated that in some embodiments of the invention, the second catalytic material may provide other functionality, such as oxidising a small amount of carbon monoxide (CO) and/or hydrocarbons (HCs).

Typically, the second catalytic material is suitable for oxidising nitric oxide (NO) to nitrogen dioxide (NO₂). The second catalytic material comprises, or consists essentially of, platinum (Pt) and a support material. It may be preferable that the second catalytic material is substantially free of, or does not comprise, palladium. More preferably, the second catalytic material comprises platinum as the only platinum group metal.

In all aspects of the second catalytic material described herein, the support material of the second catalytic material is referred to herein as the “second support material”. The label “second” is used herein to distinguish the support material of the second catalytic material from the support materials of any other catalytic materials.

Generally, the platinum is supported on the second support material. The platinum may be disposed directly onto or is directly supported by the second support material (e.g. there is no intervening support material between the platinum and the second support material). The platinum is supported on the second support material preferably by being dispersed over a surface of the second support material, more preferably by being dispersed over and fixed onto a surface of the second support material.

Typically, particles of platinum are supported on particles of the second support material. It is preferred that a particle of platinum is supported on a particle of the second support material (i.e. a surface of a particle of the second support material).

In a first aspect of the second catalytic material, the second catalytic material further comprises manganese. Thus, the second catalytic material may comprise, or consist essentially of, platinum, manganese and a second support material. The combination of manganese (Mn) and platinum (Pt) can provide excellent NO oxidation activity and can stabilise NO oxidation activity of the oxidation catalyst over its lifetime. Thus, the inclusion of manganese can reduce or prevent the deterioration in the NO oxidation activity of the catalyst as it changes from a “fresh” to an “aged” state.

The manganese is typically disposed or supported on the second support material.

In general, manganese may be disposed directly onto or is directly supported by the second support material (e.g. there is no intervening support material between the manganese and the second support material). The manganese is supported on the second support material preferably by being dispersed over a surface of the second support material, more preferably by being dispersed over and fixed onto a surface of the second support material.

The second catalytic material generally comprises particles of manganese. Particles of manganese may be supported on particles of the second support material. It is preferred that a particle of the manganese is supported on a particle of the second support material, such as a surface of a particle of the second support material. More preferably, a particle of the manganese is fixed onto a surface of a particle of the second support material.

It may be preferable that substantially all of the particles of the second catalytic material comprise, or consist essentially of, a particle of platinum and a particle of manganese supported on a particle of the second support material. More preferably, substantially all of the particles of the second catalytic material comprise, or consist essentially of, a particle of platinum and a particle of manganese fixed onto a particle of the second support material, such as a surface of a particle of the second support material.

Typically, the second catalytic material comprises a ratio by mass of Mn:Pt of ≦5:1, more preferably <5:1.

In general, the second catalytic material comprises a ratio by mass of Mn:Pt of ≧0.5:1, more preferably >0.5:1.

The second catalytic material may comprise a ratio by mass of manganese (Mn) to platinum (Pt) of 5:1 to 0.5:1 (e.g. 5:1 to 2:3), preferably 4.5:1 to 1:1 (e.g. 4:1 to 1.1:1), more preferably 4:1 to 1.5:1.

In the first aspect of the second catalytic material, the second catalytic material is substantially free of, or does not comprise, palladium.

In a second aspect of the second catalytic material, the second catalytic material comprises, or consists essentially of, platinum, a second support material and optionally palladium. In the second aspect, the second catalytic material does not comprise manganese.

The palladium is typically supported on the second support material. In general, the palladium may be disposed directly onto or is directly supported by the second support material (e.g. there is no intervening support material between the palladium and the second support material). The palladium is supported on the second support material by being dispersed over a surface of the second support material, more preferably by being dispersed over, fixed onto a surface of and/or impregnated within the second support material.

When the second catalytic material comprises palladium, it is preferred that the ratio by mass in the second catalytic material of platinum (Pt) to palladium (Pd) is >1:1. The activity of platinum toward oxidising NO to NO₂ is significantly better than that of palladium.

Typically, the second catalytic material has a ratio by mass of platinum to palladium (Pd) of ≧2:1 (e.g. Pt:Pd 1:0 to 2:1), more preferably ≧4:1 (e.g. Pt:Pd 1:0 to 4:1). Thus, the ratio by mass of Pt to Pd may be 25:1 to 4:1, such as 20:1 to 4.5:1, preferably 15:1 to 5:1 (e.g. 12.5:1 to 6:1), more preferably 10:1 to 7:1.

When the second catalytic material is for oxidising nitric oxide (NO) to nitrogen dioxide (NO₂, it is generally preferred that the second catalytic material is substantially free of palladium. More preferably, the second catalytic material does not comprise palladium. The second catalytic material preferably comprises platinum as the only platinum group metal.

In all aspects of the second catalytic material, the particles of platinum typically have a mean particle size ≦100 nm, preferably ≦50 nm, such as ≦25 nm, and more preferably ≦10 nm. Generally, the particles of platinum have a mean particle size ≧1 nm, such as ≧5 nm.

When the second catalytic material comprises palladium, then typically the particles of palladium have a mean particle size ≦100 nm, preferably ≦50 nm, such as ≦25 nm, and more preferably ≦10 nm. Generally, the particles of palladium have a mean particle size ≧1 nm, such as ≧5 nm.

The second catalytic material, particularly the second catalytic material of the second aspect, may be conditioned or aged (e.g. by calcining or thermally treating a solid form of the second catalytic material). This has the effect of converting the catalytic material into a state that would otherwise normally be reached after prolonged use in an exhaust system. Thus, any deterioration in catalytic activity, particularly oxidation of NO to NO₂, resulting from changes in the form of the catalytic material through prolonged use can be avoided. Examples of such catalytic materials are described as “catalyst compositions” in International patent application no. PCT/GB2016/050359.

When the second catalytic material is conditioned or aged, then typically the platinum has a mean crystallite size of 10 to 35 nm, such as 10 to 30 nm or 15 to 25 nm. The mean crystallite size is preferably 11 to 20 nm, particularly 12 to 18 nm. The term “mean crystallite size” in this context refers to the average (i.e. mean) coherent domain size of platinum particles on the second support material. The platinum is generally present as crystallites on the support material. Pt crystallite size can be routinely determined by using X-ray diffraction (XRD) technique (e.g. at 25° C.) and by applying established methods relating to the broadness of the diffraction peaks to determine the crystallite size. Typically, the volume averaged column height calculated from the integral breadth is used to determine the mean crystallite size.

Generally (including the first and second aspects of the second catalytic material), the second support material comprises, or consists essentially of, a refractory oxide. The refractory oxide comprises, or consists essentially of, alumina, silica, titania, zirconia or ceria, or a mixed or composite oxide thereof, such as a mixed or composite oxide of two or more thereof. For example, the mixed or composite oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

It is preferred that the refractory oxide is selected from alumina, silica-alumina and a mixture of alumina and ceria. Even more preferably, the refractory oxide is selected from alumina and silica-alumina.

When the refractory oxide is a mixed or composite oxide of silica-alumina, then preferably the refractory oxide comprises 0.5 to 45% by weight of silica (i.e. 55 to 99.5% by weight of alumina), preferably 1 to 40% by weight of silica, more preferably 1.5 to 30% by weight of silica (e.g. 1.5 to 10% by weight of silica), particularly 2.5 to 25% by weight of silica, more particularly 3.5 to 20% by weight of silica (e.g. 5 to 20% by weight of silica), even more preferably 4.5 to 15% by weight of silica.

When the refractory oxide is a mixed or composite oxide of alumina and ceria, then preferably the refractory oxide comprises at least 50 to 99% by weight of alumina, more preferably 70 to 95% by weight of alumina, even more preferably 75 to 90% by weight of alumina.

The refractory oxide may optionally be doped (e.g. with a dopant). The dopant may comprise, or consist essentially of, an element selected from the group consisting of cerium (Ce), zirconium (Zr), titanium (Ti), silicon (Si), yttrium (Y), lanthanum (La), praseodymium (Pr), samarium (Sm), neodymium (Nd) and an oxide thereof. It is preferred that an element (e.g. of the dopant) is different to an element of the refractory oxide. Thus, silica is preferably not doped with silicon.

When the refractory oxide is doped, the total amount of dopant is 0.25 to 5% by weight, preferably 0.5 to 3% by weight (e.g. about 1% by weight).

It may be preferable that the refractory oxide is not doped (e.g. with a dopant).

In the first or second aspects of the second catalytic material, when the refractory oxide comprises, or consists essentially of, alumina, then the alumina may optionally be doped (e.g. with a dopant). The dopant may comprise, or consist essentially, of silicon (Si) or an oxide thereof.

When the alumina is doped with a dopant comprising silicon or an oxide thereof, then preferably the alumina is doped with silica. The alumina is preferably doped with silica in a total amount of 0.5 to 45% by weight (i.e. % by weight of the alumina), preferably 1 to 40% by weight, more preferably 1.5 to 30% by weight (e.g. 1.5 to 10% by weight), particularly 2.5 to 25% by weight, more particularly 3.5 to 20% by weight (e.g. 5 to 20% by weight), even more preferably 4.5 to 15% by weight.

The particles of the second support material typically have a mean particle size ≦250 μm, preferably ≦200 μm, such as ≦150 μm, and more preferably ≦100 μm. Generally, the particles of the second support material have a mean particle size ≧1 μm, such as ≧10 μm.

In general, it is preferred that the second catalytic material does not comprise rhodium, particularly rhodium disposed or supported on the second support material. More preferably, the second catalytic material does not comprise rhodium, an alkali metal and/or an alkaline earth metal, particularly rhodium, an alkali metal and/or an alkaline earth metal disposed or supported on the second support material.

Typically, the second catalytic material is suitable for absorbing oxides of nitrogen (NOₓ).

In a third aspect of the second catalytic material, the second catalytic material for absorbing oxides of nitrogen (NOₓ) may comprise, or consist essentially of, a molecular sieve catalyst.

The molecular sieve catalyst comprises a noble metal and a molecular sieve. The molecular sieve catalyst is a passive NOₓ absorber (PNA) catalyst (i.e. it has PNA activity). The molecular sieve catalyst can be prepared according to the method described in WO 2012/166868.

The noble metal is typically selected from the group consisting of palladium (Pd), platinum (Pt), rhodium (Rh), gold (Au), silver (Ag), iridium (Ir), ruthenium (Ru) and mixtures of two or more thereof. Preferably, the noble metal is selected from the group consisting of palladium (Pd), platinum (Pt) and rhodium (Rh). More preferably, the noble metal is selected from palladium (Pd), platinum (Pt) and a mixture thereof.

Generally, it is preferred that the noble metal comprises, or consists of, palladium (Pd) and optionally a second metal selected from the group consisting of platinum (Pt), rhodium (Rh), gold (Au), silver (Ag), iridium (Ir) and ruthenium (Ru). Preferably, the noble metal comprises, or consists of, palladium (Pd) and optionally a second metal selected from the group consisting of platinum (Pt) and rhodium (Rh). Even more preferably, the noble metal comprises, or consists of, palladium (Pd) and optionally platinum (Pt). More preferably, the molecular sieve catalyst comprises palladium as the only noble metal.

When the noble metal comprises, or consists of, palladium (Pd) and a second metal, then the ratio by mass of palladium (Pd) to the second metal is >1:1. More preferably, the ratio by mass of palladium (Pd) to the second metal is >1:1 and the molar ratio of palladium (Pd) to the second metal is >1:1.

The molecular sieve catalyst may further comprise a base metal. Thus, the molecular sieve catalyst may comprise, or consist essentially of, a noble metal, a molecular sieve and optionally a base metal. The molecular sieve contains the noble metal and optionally the base metal.

The base metal may be selected from the group consisting of iron (Fe), copper (Cu), manganese (Mn), chromium (Cr), cobalt (Co), nickel (Ni), zinc (Zn) and tin (Sn), as well as mixtures of two or more thereof. It is preferred that the base metal is selected from the group consisting of iron, copper and cobalt, more preferably iron and copper. Even more preferably, the base metal is iron.

Alternatively, the molecular sieve catalyst may be substantially free of a base metal, such as a base metal selected from the group consisting of iron (Fe), copper (Cu), manganese (Mn), chromium (Cr), cobalt (Co), nickel (Ni), zinc (Zn) and tin (Sn), as well as mixtures of two or more thereof. Thus, the molecular sieve catalyst may not comprise a base metal.

In general, it is preferred that the molecular sieve catalyst does not comprise a base metal.

It may be preferable that the molecular sieve catalyst is substantially free of barium (Ba), more preferably the molecular sieve catalyst is substantially free of an alkaline earth metal. Thus, the molecular sieve catalyst may not comprise barium, preferably the molecular sieve catalyst does not comprise an alkaline earth metal.

The molecular sieve is typically composed of aluminium, silicon, and/or phosphorus. The molecular sieve generally has a three-dimensional arrangement (e.g. framework) of SiO₄, AlO₄, and/or PO₄ that are joined by the sharing of oxygen atoms. The molecular sieve may have an anionic framework. The charge of the anionic framework may be counterbalanced by cations, such as by cations of alkali and/or alkaline earth elements (e.g., Na, K, Mg, Ca, Sr, and Ba), ammonium cations and/or protons.

Typically, the molecular sieve has an aluminosilicate framework, an aluminophosphate framework or a silico-aluminophosphate framework. The molecular sieve may have an aluminosilicate framework or an aluminophosphate framework. It is preferred that the molecular sieve has an aluminosilicate framework or a silico-aluminophosphate framework. More preferably, the molecular sieve has an aluminosilicate framework.

When the molecular sieve has an aluminosilicate framework, then the molecular sieve is preferably a zeolite.

The molecular sieve contains the noble metal. The noble metal is typically supported on the molecular sieve. For example, the noble metal may be loaded onto and supported on the molecular sieve, such as by ion-exchange. Thus, the molecular sieve catalyst may comprise, or consist essentially of, a noble metal and a molecular sieve, wherein the molecular sieve contains the noble metal and wherein the noble metal is loaded onto and/or supported on the molecular sieve by ion exchange.

In general, the molecular sieve may be a metal-substituted molecular sieve (e.g. metal-substituted molecular sieve having an aluminosilicate or an aluminophosphate framework). The metal of the metal-substituted molecular sieve may be the noble metal (e.g. the molecular sieve is a noble metal substituted molecular sieve). Thus, the molecular sieve containing the noble metal may be a noble metal substituted molecular sieve. When the molecular sieve catalyst comprises a base metal, then the molecular sieve may be a noble and base metal-substituted molecular sieve. For the avoidance of doubt, the term “metal-substituted” embraces the term “ion-exchanged”.

The molecular sieve catalyst generally has at least 1% by weight (i.e. of the amount of noble metal of the molecular sieve catalyst) of the noble metal located inside pores of the molecular sieve, preferably at least 5% by weight, more preferably at least 10% by weight, such as at least 25% by weight, even more preferably at least 50% by weight.

The molecular sieve may be selected from a small pore molecular sieve (i.e. a molecular sieve having a maximum ring size of eight tetrahedral atoms), a medium pore molecular sieve (i.e. a molecular sieve having a maximum ring size of ten tetrahedral atoms) and a large pore molecular sieve (i.e. a molecular sieve having a maximum ring size of twelve tetrahedral atoms). More preferably, the molecular sieve is selected from a small pore molecular sieve and a medium pore molecular sieve.

In a first molecular sieve catalyst embodiment, the molecular sieve is a small pore molecular sieve. The small pore molecular sieve preferably has a Framework Type selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG and ZON, as well as a mixture or intergrowth of any two or more thereof. The intergrowth is preferably selected from KFI-SIV, ITE-RTH, AEW-UEI, AEI-CHA, and AEI-SAV. More preferably, the small pore molecular sieve has a Framework Type that is AEI, CHA or an AEI-CHA intergrowth. Even more preferably, the small pore molecular sieve has a Framework Type that is AEI or CHA, particularly AEI.

Preferably, the small pore molecular sieve has an aluminosilicate framework or a silico-aluminophosphate framework. More preferably, the small pore molecular sieve has an aluminosilicate framework (i.e. the molecular sieve is a zeolite), especially when the small pore molecular sieve has a Framework Type that is AEI, CHA or an AEI-CHA intergrowth, particularly AEI or CHA.

In a second molecular sieve catalyst embodiment, the molecular sieve has a Framework Type selected from the group consisting of AEI, MFI, EMT, ERI, MOR, FER, BEA, FAU, CHA, LEV, MWW, CON and EUO, as well as mixtures of any two or more thereof.

In a third molecular sieve catalyst embodiment, the molecular sieve is a medium pore molecular sieve. The medium pore molecular sieve preferably has a Framework Type selected from the group consisting of MFI, FER, MWW and EUO, more preferably MFI.

In a fourth molecular sieve catalyst embodiment, the molecular sieve is a large pore molecular sieve. The large pore molecular sieve preferably has a Framework Type selected from the group consisting of CON, BEA, FAU, MOR and EMT, more preferably BEA.

In each of the first to fourth molecular sieve catalyst embodiments, the molecular sieve preferably has an aluminosilicate framework (e.g. the molecular sieve is a zeolite). Each of the aforementioned three-letter codes represents a framework type in accordance with the “IUPAC Commission on Zeolite Nomenclature” and/or the “Structure Commission of the International Zeolite Association”.

The molecular sieve typically has a silica to alumina molar ratio (SAR) of 10 to 200 (e.g. 10 to 40), such as 10 to 100, more preferably 15 to 80 (e.g. 15 to 30). The SAR generally relates to a molecular having an aluminosilicate framework (e.g. a zeolite) or a silico-aluminophosphate framework, preferably an aluminosilicate framework (e.g. a zeolite).

The molecular sieve catalyst of the first, third and fourth molecular sieve catalyst embodiments (and also for some of the Framework Types of the second molecular sieve catalyst embodiment), particularly when the molecular sieve is a zeolite, may have an infrared spectrum having a characteristic absorption peak in a range of from 750 cm⁻¹ to 1050 cm⁻¹ (in addition to the absorption peaks for the molecular sieve itself). Preferably, the characteristic absorption peak is in the range of from 800 cm⁻¹ to 1000 cm⁻¹, more preferably in the range of from 850 cm⁻¹ to 975 cm⁻¹.

The molecular sieve catalyst of the first molecular sieve catalyst embodiment has been found to have advantageous passive NOₓ adsorber (PNA) activity. The molecular sieve catalyst can be used to store NOₓ when exhaust gas temperatures are relatively cool, such as shortly after start-up of a lean burn engine. NOₓ storage by the molecular sieve catalyst occurs at low temperatures (e.g. less than 200° C.). As the lean burn engine warms up, the exhaust gas temperature increases and the temperature of the molecular sieve catalyst will also increase. The molecular sieve catalyst will release adsorbed NOₓ at these higher temperatures (e.g. 200° C. or above).

It has also been unexpectedly found that the molecular sieve catalyst, particularly the molecular sieve catalyst of the second molecular sieve catalyst embodiment has cold start catalyst activity. Such activity can reduce emissions during the cold start period by adsorbing NOₓ and hydrocarbons (HCs) at relatively low exhaust gas temperatures (e.g. less than 200° C.). Adsorbed NOₓ and/or HCs can be released when the temperature of the molecular sieve catalyst is close to or above the effective temperature of the other catalyst components or emissions control devices for oxidising NO and/or HCs.

When the first catalytic material is as defined in the fourth aspect of the first catalytic material (i.e. a molecular sieve catalyst comprising a large pore molecular sieve) and the second catalytic material is as defined in the third aspect of the second catalytic material, it is preferred that the molecular sieve of the first catalytic material is different to the molecular sieve of the second catalytic material. More preferably, it is preferred that the molecular sieve of the second catalytic material is a medium pore molecular sieve or a small pore molecular sieve, even more preferably a small pore molecular sieve.

The oxidation catalyst of the invention may further comprise (c) particles of a third catalytic material.

The third catalytic material may be selected from the group consisting of a catalytic material for trapping volatilised platinum (Pt), a catalytic material for absorbing hydrocarbons (HCs), and a catalytic material for absorbing oxides of nitrogen (NOₓ).

In general, the third catalytic material comprises a support material. In all aspects of the third catalytic material described herein, the support material of the third catalytic material is referred to herein as the “third support material”. The label “third” is used herein to distinguish the support material of the third catalytic material from the support materials of any other catalytic materials.

In a first aspect of the third catalytic material, the third catalytic material may be a catalytic material for trapping volatilised platinum (Pt). When the oxidation catalyst becomes exposed to high temperatures, which may be encountered during filter regeneration, an engine upset event and/or during normal use (e.g. in certain heavy-duty diesel applications where the temperature of the exhaust gas is high), it is possible for low levels of platinum to volatilise from the oxidation catalyst. See, for example, WO 2013/08813. Platinum may subsequently become trapped on a downstream emissions control device. This can have a highly detrimental effect when the downstream emissions control devices is a selective catalytic reduction (SCR) catalyst or a selective catalytic reduction filter (SCRF™) catalyst. The presence of Pt results in a high activity toward the competing, non-selective ammonia oxidation reaction, thereby producing secondary emissions and/or unproductively consuming NH₃. The inclusion of a catalytic material for trapping volatilised platinum can reduce or prevent the volatile platinum escaping from the oxidation catalyst.

The third catalytic material for trapping volatilised platinum (Pt) may comprise a metal for trapping volatilised platinum (Pt). The metal for trapping volatilised Pt can form an alloy with the Pt. When the Pt is present in an alloy its volatility is significantly reduced.

Typically, the metal for trapping volatilised platinum is selected from the group consisting of palladium, silver, gold, copper and a combination of two or more thereof, such as a bimetallic alloy. It is preferred that the metal for trapping volatilised Pt is selected from the group consisting of palladium, silver, gold and copper. More preferably, the metal for trapping volatilised Pt is selected from the group consisting of palladium, silver and gold. Even more preferably, the metal for trapping volatilised Pt is palladium.

Particles of the metal for trapping volatilised platinum may preferably have a mean particle size≧about 10 nm, such as a mean particle size>about 10 nm. More preferably, the particles of the metal for trapping volatilised platinum have a mean particle size≧about 15 nm, such as≧about 20 nm, still more preferably≧about 50 nm, such as≧about 75 nm. Normally, it is desirable to include relatively small particles of catalytically active metals, such as Pd, Ag, Au or Cu, to maximise surface area. However, relatively large particles of such metals can trap or capture volatilised Pt whilst being relatively catalytically inactive.

Typically the metal for trapping volatilised platinum has a mean particle size of from 10 nm to 1000 micron. It is preferred that the metal for trapping volatilised platinum has a mean particle size of from 15 nm to 100 micron, more preferably 20 nm to 20 micron, particularly 50 nm to 5 micron, such as 75 nm to 3 micron.

The “mean particle size” as used herein with reference to the metal for trapping volatilised platinum can be determined by CO chemisorption (see, for example, the method described in International patent application no. PCT/GB2016/050285).

The metal for trapping volatilised Pt may be disposed or supported on a support material. Thus, the third catalytic material may comprise, or consist essentially of, a metal for trapping volatilised Pt disposed or supported on a third support material

In the first aspect of the third catalytic material, particles of the third support material may have a mean specific surface area≦about 50 m²/g (<about 50 m²/g), such as≦about 40 m²/g (<about 40 m²/g), preferably≦about 30 m²/g (<about 30 m²/g), more preferably≦about 20 m²/g (<about 20 m²/g), even more preferably≦about 10 m²/g (<about 10 m²/g). The mean specific surface area (SSA) of the particles can be determined by nitrogen physisorption at −196° C. using the volumetric method. The mean SSA is determined using the BET adsorption isotherm equation.

In the first aspect of the third catalytic material, the particles of the third support material have a relatively low mean specific surface area compared to the mean specific surface area of the support material in each of the first catalytic material and the second catalytic material.

The third support material may be a refractory oxide, a molecular sieve or a mixture of any two or more thereof. It is preferred that the third support material for the metal for trapping volatilised Pt is a refractory oxide.

Typically, the refractory oxide may be selected from the group consisting of alumina, silica, titania, zirconia, ceria and a mixed or composite oxide thereof, such as a mixed or composite oxide of two or more thereof. For example, the refractory oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

The refractory oxide may optionally be doped (e.g. with a dopant). The dopant may be selected from the group consisting of zirconium (Zr), titanium (Ti), silicon (Si), yttrium (Y), lanthanum (La), praseodymium (Pr), samarium (Sm), neodymium (Nd) and an oxide thereof.

When the refractory oxide is doped, the total amount of dopant is 0.25 to 5% by weight, preferably 0.5 to 3% by weight (e.g. about 1% by weight) of the refractory oxide.

It is preferred that the refractory oxide is not doped.

The refractory oxide is preferably selected from the group consisting of alumina, silica, ceria, silica-alumina, ceria-alumina, ceria-zirconia and alumina-magnesium oxide. More preferably, the refractory oxide is selected from the group consisting of alumina, ceria, silica-alumina and ceria-zirconia.

When the refractory oxide comprises, or consists essentially of, ceria-zirconia, then the ceria-zirconia may consist essentially of 20 to 95% by weight of ceria and 5 to 80% by weight of zirconia (e.g. 50 to 95% by weight ceria and 5 to 50% by weight zirconia), preferably 35 to 80% by weight of ceria and 20 to 65% by weight zirconia (e.g. 55 to 80% by weight ceria and 20 to 45% by weight zirconia), even more preferably 45 to 75% by weight of ceria and 25 to 55% by weight zirconia.

In a second aspect of the third catalytic material, the third catalytic material may be a catalytic material for absorbing hydrocarbons (HCs). Shortly after start-up of a compression ignition engine the exhaust gas temperature is relatively low. At such temperatures, the oxidation catalyst may be below its effective operating temperature and a significant proportion of hydrocarbons (HCs) in the exhaust gas can pass through the catalyst without being oxidised. To prevent emission of HCs into the atmosphere under such conditions, oxidation catalysts often include a catalytic material for absorbing hydrocarbons, which can trap HCs at low temperatures and release the HCs when the oxidation catalyst has reached its effective operating temperature. Such catalytic materials are typically used in light duty diesel applications.

In the second aspect, the third catalytic material for absorbing hydrocarbons (HCs) comprises, or consists essentially of, a zeolite.

The zeolite is preferably a medium pore zeolite (e.g. a zeolite having a maximum ring size of ten tetrahedral atoms) or a large pore zeolite (e.g. a zeolite having a maximum ring size of twelve tetrahedral atoms).

Examples of suitable zeolites or types of zeolite include faujasite, clinoptilolite, mordenite, silicalite, ferrierite, zeolite X, zeolite Y, ultrastable zeolite Y, AEI zeolite, ZSM-5 zeolite, ZSM-12 zeolite, ZSM-20 zeolite, ZSM-34 zeolite, CHA zeolite, SSZ-3 zeolite, SAPO-5 zeolite, offretite, a beta zeolite or a copper CHA zeolite. The zeolite is preferably ZSM-5, a beta zeolite or a Y zeolite.

In a third aspect of the third catalytic material, the third catalytic material may be a catalytic material for absorbing oxides of nitrogen (NOₓ).

The catalytic material for absorbing oxides of nitrogen (NOₓ) is formulated to adsorb NOₓ from lean exhaust gas (lambda >1) and to desorb the NOₓ when the oxygen concentration in the exhaust gas is decreased. Desorbed NOₓ may then be reduced to N₂ with a suitable reductant (e.g. engine fuel).

The third catalytic material typically comprises a NOₓ absorber component supported on ceria or ceria-zirconia. The third catalytic material preferably comprises particles of a NOₓ absorber component supported on particles of ceria or particles of ceria-zirconia.

The NOₓ absorber component may be selected from an alkaline earth metal, an alkali metal, a rare earth metal and a combination of two or more thereof.

The alkaline earth metal is preferably barium, strontium or a mixture thereof. The alkali metal is preferably potassium, sodium or a mixture thereof.

The rare earth metal is preferably lanthanum, yttrium or a mixture thereof.

It is preferred that the NOₓ absorber component is an alkaline earth metal. More preferably the NOₓ absorber component is barium.

In the third aspect, the third catalytic material may further comprise rhodium supported on a support material. It is preferred that the third catalytic material further comprises particles of rhodium supported on particles of the support material.

The support material for rhodium comprises, or consists essentially of, ceria, ceria-zirconia, alumina, an alkaline earth metal aluminate or a mixture of two or more thereof. It is preferred that the support material comprises, or consists essentially of, ceria, ceria-zirconia, alumina or an alkaline earth metal aluminate.

The alkaline earth metal aluminate is preferably magnesium aluminate (MgAl₂O₄).

When the support material comprises alumina, then the alumina may be doped with magnesium or an oxide thereof.

Generally, it is preferred that the third catalytic material is a catalytic material for trapping volatilised platinum (Pt) or a catalytic material for absorbing hydrocarbons (HCs). More preferably, the third catalytic material is for trapping volatilised platinum (Pt).

The oxidation catalyst of the invention may contain various amounts of each of the catalytic materials and their constituent components.

Typically, the oxidation catalyst comprises a total loading of the first support material of 0.1 to 4.5 g in⁻³ (e.g. 0.25 to 4.2 g in⁻³), preferably 0.3 to 3.8 g in⁻³, still more preferably 0.5 to 3.0 g in⁻³ (1 to 2.75 g in⁻³ or 0.75 to 1.5 g in⁻³), and even more preferably 0.6 to 2.5 g in⁻³ (e.g. 0.75 to 2.3 g in⁻³).

The oxidation catalyst typically comprises a total loading of platinum of 5 to 300 g ft⁻³, more preferably 10 to 250 g ft⁻³, such as 20 to 200 g ft⁻³, still more preferably 25 to 175 g ft⁻³, and even more preferably 35 to 150 g ft⁻³ (e.g. 50 to 125 g ft⁻³). For example, the oxidation catalyst may comprise a total loading of platinum of 5 to 150 g ft⁻³, more preferably 7.5 to 125 g ft⁻³, such as 10 to 110 g ft⁻³, still more preferably 25 to 100 g ft⁻³, and even more preferably 30 to 75 g ft⁻³ (e.g. 40 to 125 g ft⁻³).

When the oxidation catalyst comprises palladium, then typically the oxidation catalyst comprises a total loading of palladium of 5 to 300 g ft⁻³, more preferably 10 to 250 g ft⁻³, such as 20 to 200 g ft⁻³, still more preferably 25 to 175 g ft⁻³, and even more preferably 35 to 150 g ft⁻³ (e.g. 50 to 125 g ft⁻³). For example, the oxidation catalyst may comprise a total loading of palladium of 5 to 150 g ft⁻³, more preferably 7.5 to 125 g ft⁻³, such as 10 to 110 g ft⁻³, still more preferably 25 to 100 g ft⁻³, and even more preferably 30 to 75 g ft⁻³ (e.g. 40 to 125 g ft⁻³).

When the oxidation catalyst comprises gold, then typically the oxidation catalyst comprises a total loading of gold of 5 to 300 g ft⁻³, more preferably 10 to 250 g ft⁻³, such as 20 to 200 g ft⁻³, still more preferably 25 to 175 g ft⁻³, and even more preferably 35 to 150 g ft⁻³ (e.g. 50 to 125 g ft⁻³). For example, the oxidation catalyst may comprise a total loading of gold of 5 to 150 g ft⁻³, more preferably 7.5 to 125 g ft⁻³, such as 10 to 110 g ft⁻³, still more preferably 25 to 100 g ft⁻³, and even more preferably 30 to 75 g ft⁻³ (e.g. 40 to 125 g ft⁻³).

When the oxidation catalyst comprises an alkaline earth metal, then typically the oxidation catalyst comprises a total loading of the alkaline earth metal of 10 to 500 g ft⁻³ (e.g. 60 to 400 g ft⁻³ or 10 to 450 g ft⁻³), particularly 20 to 400 g ft⁻³, more particularly 35 to 350 g ft⁻³, such as 50 to 300 g ft⁻³, especially 75 to 250 g ft⁻³.

When the oxidation catalyst comprises bismuth, the amount of bismuth is typically 0.1 to 15.0% by weight of the first support material (e.g. the refractory oxide thereof), preferably 0.5 to 10.0% by weight (e.g. 0.75 to 5.0% by weight), more preferably 1.0 to 7.5% by weight.

When the oxidation catalyst comprises bismuth, then the oxidation catalyst typically comprises a total loading of bismuth of 5 to 500 g ft⁻³. It is preferred that the total loading of bismuth is 10 to 250 g ft⁻³ (e.g. 75 to 175 g ft⁻³), more preferably 15 to 200 g ft⁻³ (e.g. 50 to 150 g ft⁻³), still more preferably 20 to 150 g ft⁻³.

Typically, the oxidation catalyst comprises a total loading of the second support material of 0.1 to 4.5 g in⁻³ (e.g. 0.25 to 4.2 g in⁻³), preferably 0.3 to 3.8 g in⁻³, still more preferably 0.5 to 3.0 g in⁻³ (1 to 2.75 g in⁻³ or 0.75 to 1.5 g in⁻³), and even more preferably 0.6 to 2.5 g in⁻³ (e.g. 0.75 to 2.3 g in⁻³).

When the oxidation catalyst comprises manganese, then typically the oxidation catalyst comprises a total loading of manganese of 5 to 500 g ft⁻³. It is preferred that the total loading of manganese is 10 to 250 g ft⁻³ (e.g. 75 to 175 g ft⁻³), more preferably 15 to 200 g ft⁻³ (e.g. 50 to 150 g ft⁻³), still more preferably 20 to 150 g ft⁻³.

When the oxidation catalyst comprises a metal for trapping volatilised platinum, then typically the oxidation catalyst comprises a total loading of the metal for trapping volatilised platinum of 1 to 350 g ft⁻³. It is preferred that the total loading is 5 to 300 g ft⁻³, more preferably 10 to 250 g ft⁻³, still more preferably, 15 to 150 g ft⁻³, and even more preferably 20 to 100 g ft⁻³.

The oxidation catalyst may comprise a third catalytic material for absorbing hydrocarbons (HCs). The total loading of the third catalytic material for absorbing hydrocarbons (HCs) is typically 0.05 to 3.00 g in⁻³, particularly 0.10 to 2.00 g in⁻³, more particularly 0.2 to 0.8 g in⁻³. For example, the total amount of the third catalytic material for absorbing HCs may be 0.8 to 1.75 g in⁻³, such as 1.0 to 1.5 g in⁻³.

When the oxidation catalyst comprises a third catalytic material for absorbing oxides of nitrogen (NOₓ), then typically the oxidation catalyst comprises a total loading of the third catalytic material of 0.1 to 3.5 g in⁻³ (e.g. 0.1 to 1.0 g in⁻³), preferably 0.15 to 3.0 g in⁻³ (e.g. 0.15 to 0.75 g in⁻³), still more preferably 0.2 to 2.75 g in⁻³ (0.2 to 0.5 g in⁻³ or 0.75 to 2.5 g in⁻³), and even more preferably 0.5 to 2.5 g in⁻³ (e.g. 1.0 to 2.5 g in⁻³).

In general, it is preferred that oxidation catalyst of the invention does not comprise rhodium.

The invention also provides an exhaust system comprising the oxidation catalyst and an emissions control device. In general, the emissions control device is separate to the oxidation catalyst (e.g. the emissions control device has a separate substrate to the substrate of the oxidation catalyst), and preferably the oxidation catalyst is upstream of the emissions control device.

The emissions control device may be selected from a diesel particulate filter (DPF), a NOₓadsorber catalyst (NAC), a lean NOₓ catalyst (LNC), a selective catalytic reduction (SCR) catalyst, a diesel oxidation catalyst (DOC), a catalysed soot filter (CSF), a selective catalytic reduction filter (SCRF) catalyst, and combinations of two or more thereof. Emissions control devices represented by the terms diesel particulate filters (DPFs), NOₓ adsorber catalysts (NACs), lean NOₓ catalysts (LNCs), selective catalytic reduction (SCR) catalysts, diesel oxidation catalyst (DOCs), catalysed soot filters (CSFs) and selective catalytic reduction filter (SCRF™) catalysts are all well known in the art.

The NOₓ adsorber catalyst (NAC) may be a passive NOₓ absorber (PNA) catalyst or a lean NOₓ trap (LNT).

In a first exhaust system embodiment, the exhaust system further comprises a diesel particulate filter (DPF) or a catalysed soot filter (CSF). The oxidation catalyst of the invention is typically followed by (e.g. is upstream of) the diesel particulate filter (DPF) or the catalysed soot filter (CSF). Thus, for example, an outlet of the oxidation catalyst is connected to an inlet of the DPF or the CSF.

It is preferred that the oxidation catalyst is directly followed by, or is directly upstream of, (e.g. there is no intervening emissions control device) the DPF or the CSF. An outlet of the oxidation catalyst is preferably directly connected to an inlet of the diesel particulate filter or the catalysed soot filter.

In a second exhaust system embodiment, the exhaust system further comprises a selective catalytic reduction (SCR) catalyst. The oxidation catalyst of the invention is typically followed by (e.g. is upstream of) the selective catalytic reduction (SCR) catalyst. It is preferred that the oxidation catalyst is directly followed by, or is directly upstream of, the SCR catalyst.

A third exhaust system embodiment further comprises a selective catalytic reduction filter (SCRF™) catalyst. The oxidation catalyst of the invention is typically followed by (e.g. is upstream of) the selective catalytic reduction filter (SCRF™) catalyst. It is preferred that the oxidation catalyst is directly followed by, or is directly upstream of, the SCR catalyst.

A fourth exhaust system embodiment relates to an exhaust system further comprising a diesel particulate filter or a catalysed soot filter (CSF), and a selective catalytic reduction (SCR) catalyst. The oxidation catalyst of the invention is typically followed by (e.g. is upstream of) the diesel particulate filter or the catalysed soot filter (CSF). The DPF or CSF is typically followed by (e.g. is upstream of) the selective catalytic reduction (SCR) catalyst.

It is preferred that the oxidation catalyst is directly followed by, or is directly upstream of, (e.g. there is no intervening emissions control device) the DPF or the CSF. More preferably, the DPF or the CSF is directly followed by, or is directly upstream of, the SCR catalyst.

In a fifth exhaust system embodiment, the exhaust system further comprises a selective catalytic reduction (SCR) catalyst and either a catalysed soot filter (CSF) or a diesel particulate filter (DPF). The oxidation catalyst of the invention is typically followed by (e.g. is upstream of) the selective catalytic reduction (SCR) catalyst. The selective catalytic reduction (SCR) catalyst is typically followed by (e.g. is upstream of) the catalysed soot filter (CSF) or the diesel particulate filter (DPF).

It is preferred that the oxidation catalyst is directly followed by, or is directly upstream of, (e.g. there is no intervening emissions control device) the SCR catalyst. More preferably, the SCR catalyst is directly followed by, or is directly upstream of, the CSF or the DPF.

In a sixth exhaust system embodiment, the exhaust system further comprises a NOₓ adsorber catalyst (NAC) and the oxidation catalyst of the invention, preferably as a catalysed soot filter (CSF). The NOₓ adsorber catalyst (NAC) is typically followed by (e.g. is upstream of) the oxidation catalyst of the invention. It is preferred that the NOₓ adsorber catalyst (NAC) is directly followed by, or is directly upstream of, the oxidation catalyst.

The sixth exhaust system embodiment may further comprise a selective catalytic reduction (SCR) catalyst. Typically the NOₓ adsorber catalyst (NAC) is followed by (e.g. is upstream of) the oxidation catalyst of the invention, and the oxidation catalyst of the invention is followed by (e.g. is upstream of) the selective catalytic reduction (SCR) catalyst. It is preferred that the oxidation catalyst is directly followed by, or is directly upstream of, the SCR catalyst.

When the exhaust system of the invention comprises an SCR catalyst, then the exhaust system may further comprise an injector for injecting a nitrogenous reductant, such as ammonia or urea, into exhaust gas downstream of the oxidation catalyst of the invention and upstream of the SCR catalyst or the SCRF™ catalyst.

In the second, fifth and sixth exhaust system embodiments, the injector may be disposed between the oxidation catalyst and the SCR catalyst.

In the third exhaust system embodiment, the injector may be disposed between the oxidation catalyst and the SCRF™ catalyst.

In the fourth exhaust system embodiment, the injector may be disposed between the oxidation catalyst and either the DPF or the CSF. Alternatively, the injector may be disposed between the DPF or the CSF and the SCR catalyst. It is preferred that the injector is disposed between the DPF or the CSF and the SCR catalyst.

Alternatively or in addition to the injector, the exhaust system may further comprise an engine management means for enriching the exhaust gas with hydrocarbons. Ammonia can be generated in situ e.g. during rich regeneration of a NAC disposed upstream of the filter. The SCR catalyst or the SCRF™ catalyst can then use the hydrocarbons as a reductant to reduce NOₓ.

The invention also provides an apparatus or a vehicle. The apparatus or vehicle comprises a compression ignition engine and either an exhaust system of the invention or an oxidation catalyst of the invention.

Generally, the compression ignition engine is a diesel engine. The diesel engine may be a homogeneous charge compression ignition (HCCI) engine, a pre-mixed charge compression ignition (PCCI) engine or a low temperature combustion (LTC) engine. It is preferred that the diesel engine is a conventional (i.e. traditional) diesel engine.

The vehicle may be a light-duty diesel vehicle (LDV), such as defined in US or European legislation. A light-duty diesel vehicle typically has a weight of <2840 kg, more preferably a weight of <2610 kg.

In the US, a light-duty diesel vehicle (LDV) refers to a diesel vehicle having a gross weight of ≦8,500 pounds (US lbs). In Europe, the term light-duty diesel vehicle (LDV) refers to (i) passenger vehicles comprising no more than eight seats in addition to the driver's seat and having a maximum mass not exceeding 5 tonnes, and (ii) vehicles for the carriage of goods having a maximum mass not exceeding 12 tonnes.

Alternatively, the vehicle may be a heavy-duty diesel vehicle (HDV), such as a diesel vehicle having a gross weight of >8,500 pounds (US lbs), as defined in US legislation.

A further aspect of the invention relates to a method of preparing the oxidation catalyst.

Step (i) of the method comprises preparing a washcoat comprising (a) particles of the first catalytic material and (b) particles of a second catalytic material by dispersing the particles of the first catalytic material and the particles of the second catalytic material in a liquid.

The term “washcoat” as used herein is known in the art. This term refers to an adherent coating that is applied to a substrate during the production of a catalyst.

When the oxidation catalyst comprises a third catalytic material, then step (i) of the method may comprise:
(i) preparing a washcoat comprising:
   (a) particles of a first catalytic material for oxidising carbon monoxide (CO) and/or hydrocarbons (HCs),
   (b) particles of a second catalytic material for oxidising nitric oxide (NO) and/or for absorbing oxides of nitrogen (NOₓ),
   (c) particles of a third catalytic material, such as described above,
      by dispersing the particles of the first catalytic material, the particles of the second catalytic material and the particles of the third catalytic material in a liquid.

For the avoidance of doubt, step (i) comprises dispersing the particles of the first catalytic material, the particles of the second catalytic material and optionally the particles of the third catalytic material, in a single (i.e. the same) liquid.

The liquid may be a solution or a suspension, such as an aqueous solution or an aqueous suspension.

The liquid may comprise a washcoat modifier. The washcoat modifier may be a binder, a rheology modifier and/or a pH modifier (e.g. an acidic or basic compound). Such washcoat modifiers are well known in the art.

In step (i), the particles of the first catalytic material are typically in a solid form, such as a solid, powder form.

In step (i), the particles of the second catalytic material are typically in a solid form, such as a solid, powder form.

When the method involves a third catalytic material, then in step (i) the particles of the third catalytic material are typically in a solid form, such as a solid, powder form.

Each of the catalytic materials (i.e. the first, second and/or third catalytic material) is independently pre-prepared in a solid form, particularly a solid, powder form. The pre-preparation of the catalytic materials can be performed using conventional methods, such as by using solid phase methods (e.g. flame spray pyrolysis, chemical vapour deposition) or solution phase methods (e.g. preparing the catalytic material in solution and then isolating the material in a solid form, dissolution-precipitation, spray-drying). The catalytic material may be subjected to one or more purification steps (e.g. to remove unwanted by-products) during its preparation.

In step (i), the step of dispersing in a liquid includes dissolving the particles in the liquid and/or suspending the particles in the liquid. Several factors, such as the nature of the liquid and the solubility of the particles of the catalytic materials, will determine whether dissolution and/or suspension of the particles occur in this step.

The catalytic materials may be dispersed in the liquid simultaneously or sequentially.

The step of dispersing the particles of the first catalytic material and the particles of the second catalytic material in a liquid may comprise admixing
(a1) a solution, a suspension or a powder comprising particles of the first catalytic material; and/or
(a2) a solution, a suspension ora powder comprising particles of the second catalytic material,
   into the liquid.

In (a1), the powder comprising particles of the first catalytic material is preferred.

In (a2), the powder comprising particles of the second catalytic material is preferred.

When the oxidation catalyst comprises a third catalytic material, then the step of dispersing the particles of the first catalytic material and the particles of the second catalytic material in a liquid may comprise admixing (a3) a solution, a suspension or a powder comprising particles of the third catalytic material into the liquid. The powder comprising particles of the second catalytic material is preferred.

Step (ii) of the method comprises coating a substrate with the washcoat. Methods for coating a substrate with a washcoat are known in the art. See, for example, WO 99/47260, WO 2007/077462 and WO 2011/080525.

The method of the invention may further comprise:

(iii) drying and/or calcining the substrate with the washcoat (e.g. to form catalytic coating disposed on the substrate).

Step (iii) is performed after all of the above steps. Suitable drying and calcination conditions depend on the composition of the washcoat and the type of substrate. Such drying and calcination conditions are known in the art.

In general, it is preferred that the method of the invention comprises a single step of coating a substrate with a washcoat.

Definitions

Any reference herein to a loading in units of g ft⁻³ (grams per cubic foot) or g in⁻³ (grams per cubic inch) etc. refer to the mean weight of a component per volume of the substrate.

The term “mixed oxide” as used herein generally refers to a mixture of oxides in a single phase, as is conventionally known in the art. The term “composite oxide” as used herein generally refers to a composition of oxides having more than one phase, as is conventionally known in the art.

As used herein, the term “platinum” embraces “platinum (e.g. in metallic form) and/or an oxide thereof”, the term “palladium” embraces “palladium (e.g. in metallic form) and/or an oxide thereof”, and the term “manganese” embraces “manganese (e.g. in metallic form) and/or an oxide thereof”, unless otherwise indicated. During use of the oxidation catalyst, some or all of the platinum, palladium or manganese may be present in the form of an oxide.

As used herein, the term “alkaline earth metal” embraces “alkaline earth metal (e.g. in metallic form), an oxide of the alkaline earth metal and/or a carbonate of the alkaline earth metal”, unless otherwise indicated. During use of the oxidation catalyst, some or all of the alkaline earth metal may be present in the form of an oxide and/or a carbonate.

It is to be understood that the reference to an “oxidation catalyst” as used herein may refer to a catalyst that is, or is for use as, a diesel oxidation catalyst (DOC), a catalysed soot filter (CSF), a cold start concept (CSC™) catalyst, a passive NOₓ adsorber (PNA) or a lean NOₓ trap (LNT). A cold start concept (CSC™) catalyst is described in WO 2012/166868.

The term “substantially all” as used herein with reference to the structure of the particles of a catalytic material refers to at least 95% by weight of the particles of the catalytic material having the specified structure, typically at least 99% by weight, such as at least 99.5% by weight.

The term “substantially free” as used herein in the context of a particular chemical entity (e.g. palladium) refers to a catalytic material that contains less than 0.5% by weight of the chemical entity, typically less than 0.1% by weight of the chemical entity, such as less than 0.01% by weight of the chemical entity. Generally, the chemical entity is not detectable using conventional analytical techniques.

The expression “consisting essentially” used herein limits the scope of a feature to include the specified materials or steps, and any other materials or steps that do not materially affect the basic characteristics of that feature, such as for example minor impurities. The expression “consisting essentially of” embraces the expression “consisting of”.

### EXAMPLES

The invention will now be illustrated by the following non-limiting examples.

### Example 1

### Reference

Silica-alumina powder was slurried in water and milled to a d₉₀<20 micron. Barium acetate was added to the slurry followed by appropriate amounts of soluble platinum and palladium salts. Beta zeolite was added and the slurry was stirred to homogenise. The resulting washcoat was applied to a cordierite flow through monolith having 400 cells per square inch using established coating techniques. The part was then dried and calcined at 500° C. The first coating layer had a precious metal loading of 20 g ft⁻³ and Pt:Pd weight ratio of 1:1.

A second slurry of alumina was milled to a d₉₀<20 micron. Soluble platinum salt was added and the slurry stirred to homogenise. This washcoat was applied to the flow through monolith. The second coating was dried and calcined at 500° C. The second coating layer had a Pt metal loading of 30 g ft⁻³.

The total precious metal loading of the finished part was 50 g ft⁻³, and Pt:Pd weight ratio was 4:1. The zeolite loading was 0.5 g in⁻³.

### Example 2

Preparation of Powder P1

Silica-alumina powder was impregnated with soluble salts of platinum and palladium by an incipient wetness method. The powder was dried then re-slurried in water and treated with an aqueous solution of hydrazine at 55° C. to reduce the platinum group metals (PGMs). The reduced slurry was filtered, dried and then calcined at 500° C. The resulting powder has a Pt:Pd weight ratio of 1:1 and a total precious metal loading of 1.45 wt %.

Preparation of Powder P2

Alumina powder was impregnated with platinum nitrate solution by an incipient wetness method. The powder was dried then re-slurried in water and treated with an aqueous solution of hydrazine at 55° C. to reduce the Pt. The reduced slurry was filtered, dried and then calcined at 500° C. The resulting powder has a Pt loading of 2.9 wt %.

Preparation of the Catalyst

Preformed powder P1 was slurried in water and milled to a d₉₀<20 micron. Barium acetate was added to the slurry followed by beta zeolite. The slurry was then stirred to homogenise. The resulting washcoat was applied to a cordierite flow through monolith having 400 cells per square inch using established coating techniques. The part was then dried and calcined at 500° C. The first coating layer had a precious metal loading of 20 g ft⁻³ and Pt:Pd weight ratio of 1:1.

Preformed powder P2 was slurried in water and milled to a d₉₀<20 micron. This washcoat was applied to the flow through monolith. The second coating was dried and calcined at 500° C. The second coating layer had a Pt metal loading of 30 g ft⁻³

The total precious metal loading of the finished part was 50 g ft⁻³, and Pt:Pd weight ratio was 4:1. The zeolite loading was 0.5 g in⁻³.

### Example 3

Powders P1 and P2 of Example 2 were used in this example.

Preformed powder P1 was slurried in water and milled to a d₉₀<20 micron. Preformed powder P2 was slurried in water and milled to a d₉₀<20 micron. The P1 and P2 milled slurries were combined and mixed. Barium acetate was added followed by beta zeolite. The resulting washcoat was applied to a cordierite flow through monolith having 400 cells per square inch using established coating techniques. The part was then dried and calcined at 500° C. The total precious metal loading of the finished part was 50 g ft⁻³, and Pt:Pd weight ratio was 4:1. The zeolite loading was 0.5 g in⁻³.

Experimental Results

Measurement of Catalytic Activity

Core samples were taken from the catalysts of Examples 1, 2 and 3. Cores were hydrothermally aged in an oven at 750° C. for 15 hours using 10% water.

Catalytic activity was determined using a synthetic gas bench catalytic activity test (SCAT). The aged cores were tested in a simulated exhaust gas mixture shown in Table 1. In each case the balance is nitrogen. The oxidation activity for NO is determined as the percentage conversion at 250° C. The oxidation activity for CO is determined by the light off temperature whereby 50% conversion is achieved (T50). The oxidation activity for hydrocarbons (HC) is determined by the light off temperature whereby 60% conversion is achieved (T60). The results from the SCATs are shown in Tables 2 and 3 below.

TABLE 1

| | |
|---|---|
| CO | 1500 ppm |
| HC (as C₁) | 430 ppm |
| NO | 100 ppm |
| CO₂ | 4% |
| H₂O | 4% |
| O₂ | 14% |
| Space velocity | 55000/hour |

TABLE 2

| | T50 CO aged condition | |
|---|---|---|
| Example No. | (° C.) | T60 HC aged condition (° C.) |
| 1 | 168 | 171 |
| 2 | 169 | 173 |
| 3 | 170 | 171 |

The results in Table 2 show the CO T50 and HC T60 light off temperatures for Examples 1, 2 and 3. All of the catalysts have similar light off temperatures. Examples 2 and 3 comprise preformed powders. Example 3 comprises preformed powders in a single layer, and has a similar light off activity for CO and HC to the catalysts with more than one layer.

TABLE 3

| | Aged core NO oxidation at 250° C. |
|---|---|
| Example No. | (%) |
| 1 | 56 |
| 2 | 64 |
| 3 | 54 |

The results in Table 3 show the NO oxidation performance of Examples 1, 2 and 3 at 250° C. Examples 2 and 3 comprise preformed powders. Example 2 has the highest NO oxidation activity and shows a benefit from using preformed powders in a two layer design. Example 3 shows similar NO oxidation activity as Example 1. Example 3 shows similar NO oxidation activity to Example 1 even though it has a single layer.

Vehicle Testing

The catalysts of Examples 1 and 3 were hydrothermally aged at 750° C. for 15 hours. The aged catalysts were fitted in a close coupled position to a Eu5 light duty passenger car equipped with a 1.6 litre common rail diesel engine. The vehicle was driven on a chassis dynamometer using the New Emissions Drive Cycle (NEDC). Three NEDC tests were run on each catalyst to stabilise the activity. CO and HC oxidation activity is determined as the percentage conversion of cumulative NEDC emissions across the catalyst. The results from the third cycle are shown in Table 4.

TABLE 4

| Example No. | % CO conversion | % HC conversion |
|---|---|---|
| 1 | 63 | 80 |
| 3 | 70 | 83 |

The results in Table 4 show the percentage CO and HC conversions of Examples 1 and 3 over the NEDC. Example 3 is a single layer catalyst comprising preformed powders. Example 3 shows higher conversion of CO and HC than Example 1 over the transient NEDC test.

For the avoidance of doubt, the content of any document referenced herein is incorporated in its entirety.

1. An oxidation catalyst for treating an exhaust gas produced by a compression ignition engine, wherein the oxidation catalyst comprises a substrate and a catalytic coating disposed on the substrate, wherein the catalytic coating comprises a mixture of:
(a) particles of a first catalytic material for oxidising carbon monoxide (CO) and/or hydrocarbons (HCs);
(b) particles of a second catalytic material for oxidising nitric oxide (NO) and/or for absorbing oxides of nitrogen (NOₓ).

2. An oxidation catalyst according to claim 1, wherein the first catalytic material comprises (i) platinum, (ii) a first support material, and (iii) a component selected from the group consisting of palladium, a promoter and a combination of palladium and a promoter.

3. An oxidation catalyst according to claim 2, wherein the first catalytic material comprises (i) platinum (Pt), (ii) a first support material, and (iii) a component selected from the group consisting of a promoter and a combination of palladium and a promoter, and wherein the promoter comprises at least one of (a) an alkaline earth metal or an oxide, hydroxide or carbonate thereof, and (b) bismuth or an oxide thereof.

4. An oxidation catalyst according to claim 3, wherein the first support material comprises a refractory oxide, and wherein the refractory oxide comprises alumina, silica or a mixed or composite oxide of silica and alumina.

5. An oxidation catalyst according to claim 4, wherein the refractory oxide comprises alumina, wherein the alumina is doped with a dopant comprising silicon or an oxide thereof.

6. An oxidation catalyst according to claim 1, wherein the second catalytic material is for oxidising nitric oxide (NO) and comprises platinum and a second support material.

7. An oxidation catalyst according to claim 6, wherein the second catalytic material further comprises manganese.

8. An oxidation catalyst according to claim 7, wherein the second support material comprises a refractory oxide, and wherein the refractory oxide comprises alumina, silica or a mixed or composite oxide of silica and alumina.

9. An oxidation catalyst according to claim 8, wherein the refractory oxide comprises alumina, wherein the alumina is doped with a dopant comprising silicon or an oxide thereof.

10. An oxidation catalyst according to claim 1 further comprising a third catalytic material for absorbing hydrocarbons (HCs), which comprises a zeolite.

11. An oxidation catalyst according to claim 1 further comprising a third catalytic material for absorbing oxides of nitrogen (NOₓ), which comprises a NOₓ absorber component supported on ceria or ceria-zirconia, wherein the NOₓ absorber component is selected from an alkaline earth metal, an alkali metal, a rare earth metal and a combination of two or more thereof.

12. An oxidation catalyst according to claim 1, wherein the substrate is flow-through monolith or a filtering monolith.

13. An exhaust system for treating an exhaust gas produced by a compression ignition engine comprising an oxidation catalyst according to claim 1.

14. A vehicle comprising a compression ignition engine and an exhaust system according to claim 13.

15. A method of preparing an oxidation catalyst for a compression ignition engine, which method comprises:
(i) preparing a washcoat comprising:
(a) particles of a first catalytic material for oxidising carbon monoxide (CO) and/or hydrocarbons (HCs), and
(b) particles of a second catalytic material for oxidising nitric oxide (NO) and/or for absorbing oxides of nitrogen (NOₓ),
by dispersing the particles of the first catalytic material and the particles of the second catalytic material in a liquid; and
(ii) coating a substrate with the washcoat.

16. A method according to claim 15, wherein step (i) is a step of:
(i) preparing a washcoat comprising:
(a) particles of a first catalytic material for oxidising carbon monoxide (CO) and/or hydrocarbons (HCs),
(b) particles of a second catalytic material for oxidising nitric oxide (NO) and/or for absorbing oxides of nitrogen (NOₓ),
(c) particles of a third catalytic material,
by dispersing the particles of the first catalytic material, the particles of the second catalytic material and the particles of the third catalytic material in a liquid.

17. A method according to claim 15, wherein the liquid is an aqueous solution or an aqueous suspension.

18. A method according to claim 15, wherein the liquid comprises a washcoat modifier, which is a binder, a rheology modifier and/or a pH modifier.
